(19) United States
(12) Patent Application Publication
(10) Pub. No.: US 2014/0281934 A1
(43) Pub. Date: Sep. 18, 2014

(54) METHOD AND APPARATUS FOR DISPLAY ADJUSTMENT

(71) Applicant: TENCENT TECHNOLOGY (SHENZHEN) COMPANY LIMITED, Shenzhen City (CN)

(72) Inventor: Hang ZHANG, Shenzhen City (CN)

(73) Assignee: TENCENT TECHNOLOGY (SHENZHEN) COMPANY LIMITED, Shenzhen City (CN)

(21) Appl. No.: 14/231,803

(22) Filed: Apr. 1, 2014

Related U.S. Application Data
(63) Continuation of application No. PCT/CN2013/088795, filed on Dec. 6, 2013.

(30) Foreign Application Priority Data
Mar. 18, 2013 (CN) 201310085908.2

(51) Int. Cl. G06F 17/21

(52) U.S. Cl. CPC G06F 17/212
USPC 715/243

(57) ABSTRACT

The present invention discloses a method and apparatus for display adjustment, relates to the field of applications of electronic devices, and can solve the problem of inconvenience during the adjustment to the display content. The method provided in the present invention includes: acquiring a first parameter, the first parameter being used for adjusting display content; displaying a display effect corresponding to the first parameter in a preview interface; if receiving a confirmation instruction, then adjusting the display content according to the first parameter. The present invention is mainly applied in the process of rearranging the layout of a browser page.

This application is a continuation of International Application No. PCT/CN2013/088795 filed on Dec. 6, 2013, which claims priority to Chinese Patent Application No. 201310085908.2 filed on Mar. 18, 2013, the contents of which are incorporated by reference herein in their entirety.

### TECHNICAL FIELD

The present invention relates to the application field of electronic devices, and particularly to a method and apparatus for display adjustment.

### BACKGROUND ART

When a user uses an electronic device such as a mobile phone, a computer, or the like, usually he/she would adjust display content according to his/her own browsing habits, for example, adjusting locations of icons on the desktop, adjusting a size of the displayed text, and so on. When adjusting the display content, the user needs to access a setting menu and look progressively for options of settings, make settings and thereafter confirm an exit from the setting menu, thereby completing the adjustment to the display content. Taking Symbian commonly used in mobile phones as an example, when the user makes an adjustment to the size of font displayed on a browser page, first a setting dialog box needs to be clicked, then the size of font is selected and an OK button is clicked to exit from the setting dialog box. The mobile phone accordingly modifies the size of font on the browser page to be the size of font newly selected by the user, thus completing the adjustment to the size of font.

In the above-mentioned display adjustment process, the inventor finds that at least the following problem exists in the prior art: the dialog box generally used in mobile phones or computers is a modal dialog box (also called mode dialog box), when a modal dialog box is opened, only the current modal dialog box can receive a key event triggered by the user, if the user wants to operate an application outside the dialog box, he/she must first execute a click response to the dialog box, such as OK, Cancel etc. With respect to the display adjustment, the mobile phone is able to adjust the display content only after the user sets an adjustment parameter in the dialog box and confirms to exit from the dialog box. If the user needs to view and modify the adjustment effect repeatedly, he/she needs to open and close the dialog box multiple times and the operations are very troublesome.

### SUMMARY OF THE INVENTION

Embodiments of the present invention provide a method and apparatus for display adjustment, being capable of solving the problem of inconvenience during the adjustment to the display content.

In an aspect, an embodiment of the present invention provides a method for display adjustment, including:
acquiring a first parameter, the first parameter being used for adjusting display content;
displaying a display effect corresponding to the first parameter in a preview interface; and
if receiving a confirmation instruction, then adjusting the display content according to the first parameter.

In another aspect, an embodiment of the present invention provides an apparatus for display adjustment, including:
an acquiring unit for acquiring a first parameter, the first parameter being used for adjusting display content;
a display unit for displaying a display effect corresponding to the first parameter in a preview interface;
a receiving unit for receiving a confirmation instruction; and
an adjusting unit for, when the receiving unit receives the confirmation instruction, adjusting the display content according to the first parameter acquired by the acquiring unit.

The method and apparatus for display adjustment provided by the embodiments of the present invention can acquire the first parameter used for adjusting the display content, display a display effect corresponding to the first parameter in the preview interface, when receiving a confirmation instruction, adjust the display content according to the first parameter. As compared with that the mobile phone can display the adjusted display content only after the user sets an adjustment parameter and confirms an exit from the setting dialog box in the prior art, the present invention can pre-display a display effect corresponding to an adjustment parameter selected by the user during the process of setting the adjustment parameter, with respect to the case where the setting dialog box is a modal dialog box, the display effect can be provided to the user without closing the setting dialog box, therefore, the times of opening and closing the setting dialog box are reduced, and the user's operation steps are simplified.

### BRIEF INTRODUCTION TO THE DRAWINGS

In order to more clearly illustrate the technical solutions in the embodiments of the present invention or in the prior art, accompanying drawings required for description of the embodiments thereof or the prior art will be introduced briefly below. Obviously, the accompanying drawings described below are merely some embodiments of the present invention, a person of ordinary skill in the art may also obtain other accompanying drawings based on these accompanying drawings under the premise of paying no creative efforts.

FIG. 1 is a flowchart of a method for display adjustment in an embodiment of the present invention;

FIG. 2 is a flowchart of another method for display adjustment in an embodiment of the present invention;

FIGS. 3(a) to 3(f) are schematic diagrams of an interface during the display adjustment process in an embodiment of the present invention;

FIGS. 4(a) to 4(d) are schematic diagrams of a preview interface having background lines in an embodiment of the present invention;

FIG. 5 is a schematic diagram of location of the preview interface in an embodiment of the present invention;

FIG. 6 is a flowchart of a method for adjusting size of text on a browser page in an embodiment of the present invention; and

FIG. 7 is a structural schematic diagram of an apparatus 71 for display adjustment in an embodiment of the present invention.

### BEST MODES FOR CARRYING OUT THE INVENTION

The technical solutions in the embodiments of the present invention will be clearly and fully described hereinafter with reference to the accompanying drawings therein. Obviously, the embodiments to be described are not all of the embodiments of the present invention, but only parts of the embodiments thereof. Other embodiments obtained by a person of ordinary skill in the art based on the embodiments of the present invention without paying creative efforts all fall into the protection scope of the present invention.

This embodiment provides a method for display adjustment, the method being mainly applied in electronic devices, which include, but not limited to, mobile terminals such as mobile phones and PDA and fixed terminals such as computers. As shown in FIG. 1, the method includes:

101. Acquiring a first parameter in a setting dialog box, the first parameter being used for adjust display content.

In this embodiment, the adjustment to the display content may be an adjustment to the display content in entirety, such as zooming in/out the page entirely, and may be also an adjustment to parts of the display content, such as adjusting size of text on a page or adjusting location of a picture on a page. The first parameter is a parameter used for adjusting the display content, when adjusting the size of text, the first parameter is font size of the text; when adjusting the location of a picture, the first parameter is coordinates of a center point of the picture. The first parameter in this embodiment is selected by the user and acquired by an electronic device, when there is a need to adjust the display content, the electronic device opens the setting dialog box, and thereafter acquires the first parameter selected by the user in the setting dialog box.

102. Looking up a display effect corresponding to the first parameter.

A mapping correspondence table used to characterize correspondences between the first parameter and the display effect is pre-stored in the electronic device, the preimage entries in the mapping correspondence table are a set of the first parameters, and the image entries therein are a set of the display effects, typically the preimage entries and the image entries in the mapping correspondence table have a one-to-one mapping relationship. Taking adjusting the size of text as an example, the preimage entries are a set of font sizes, the image entries are a set of display effects, the mapping correspondence table may be formed as below:

| Font Sizes | Image Identifiers of Display Effects |
|---|---|
| 8 | A1 |
| 9 | B2 |
| . . . | . . . |
| 36 | F9 |

Typically, the display effect is reflected in form of image, thus the display effects in the image entries may be reflected in form of image identifiers. For example, in the above table, the electronic device previously numbers the display effects, and thereafter adds the numbers of the display effects to the image entries in the mapping correspondence table. In addition, the display effects in the image entries may be also be, but not limited to, reflected in form of logical or physical storage addresses.

103. Displaying the display effect in a preview interface.

After the display effect corresponding to the first parameter has been looked up, the electronic device displays the display effect in a preview interface. The preview interface may occupy the entire display area of the screen, and may also occupy parts of display area of the screen. When the preview interface occupies parts of the display area of the screen, the location of the preview interface had better not block the main body of the display content.

104. If receiving a confirmation instruction, then adjusting the display content according to the first parameter and closing the setting dialog box.

After displaying the display effect, if the user is satisfied with the display effect, the electronic device receives a confirmation instruction triggered by the user, and thereafter adjusts the display content according to the first parameter acquired in step 101 and closes the setting dialog box.

It should be explained that, the display effect displayed in step 103 is used only for effect revelation, and its content is irrelevant with the display content that is being currently displayed by the electronic device. When the electronic device is displaying the display effect, it has not adjusted the display content yet, the electronic device will adjust the display content according to the first parameter (i.e., the parameter corresponding to the display effect) only after receiving the confirmation instruction. Still taking adjusting the size of text as an example, the font size of text on a page currently displayed by the electronic device is font 10, the first parameter received by the electronic device is font 12, the electronic device displays, with the word “ [symbol] ” as a template, the word “ [symbol] ” in font 12 in the preview interface, while at present, the font size of text on the page still is font 10. When satisfied with font 12, the user triggers a confirmation instruction, the electronic device adjusts the font size of text on the page to font 12 according to the confirmation instruction and closes the setting dialog box; when not satisfied with font 12, the user re-selects a font size, such as displaying with font 16, the electronic device repeatedly executes steps 101 to 103 in order, in order to obtain a first parameter of font 16, and display the word “ [symbol] ” in font 16, when the user is satisfied with font 16, the electronic device receives a confirmation instruction, adjusts the font size of text on the page to font 16 according to the confirmation instruction and closes the setting dialog box.

In the prior art, the user clicks to open a setting dialog box, selects a parameter used for adjusting the display content in the setting dialog box, and thereafter clicks an OK button to exit from the setting dialog box, after the user exits from the setting dialog box, the electronic device adjusts the display content according to the parameter selected by the user. Since the user cannot intuitively acquire the adjustment effect to the display content via the parameter per se, the adjusted display content can be viewed posteriorly only after the setting is completed. If not satisfied with the adjustment result of the display content, the user needs to re-open the setting dialog box to make a parameter selection. Typically, the path of the setting dialog box is relatively deep, the user needs to click multi-levels of setting menu so that he/she can open the setting dialog box, thus repeatedly opening the setting dialog box will adds a number of operation steps, which reduces the user's operating experience. In this embodiment, after the user opens the setting dialog box, the electronic device can look up and pre-display the display effect according to the first parameter selected by the user, and make no adjustment to the display content while pre-displaying the display effect. If not satisfied with the display effect, the user can re-select the first parameter without closing the setting dialog box, the electronic device will exit from the setting dialog box and adjust the display content according to the first parameter confirmed by the user until the user is satisfied with the display effect and triggers the confirmation instruction. As compared with the prior art, the inconvenience caused by the properties of the modal dialog box to the setting by the user can be solved, thus user operations are simplified.

The method for display adjustment in this embodiment will be explained in detail and further extended in conjunction with the implementation of the method shown in FIG. 1 hereinafter. As shown in FIG. 2, the method includes:

201. The electronic device receives an adjusting instruction.

The adjusting instruction is used to instruct the electronic device to adjust display content. In particular, as shown in FIG. 3(a), the path of the adjusting instruction may be: Settings→Screen Settings→Adjust Display Content, wherein the page content in the display area of the screen is an adjustment object, that is, the display content to be adjusted.

202. The electronic device displays a setting dialog box according to the adjusting instruction.

The electronic device displays second parameters used for adjusting the display content in the setting dialog box, the second parameters are alternative parameters. In this embodiment, when the display content is characters, the second parameters may be at least one of the following parameters: font size, font, or style; when the display content is an picture or an icon, the second parameters may be: size or location.

1) Take adjusting the size of text as an example, as shown in FIG. 3(b), the second parameters are font 8 to font 30, the user can select any font size between font 8 to font 30 (including endpoints) to make settings.

2) Take adjusting the font of text as an example, as shown in FIG. 3(c), the second parameters are a variety of font parameters including Kati ( [symbol] ), Songti ( [symbol] [symbol] ), Yaoti ( [symbol] ), XingKai ( [symbol] ) etc., the user can select any font among them to make settings.

3) Take adjusting the style of text as an example, as shown in FIG. 3(d), the second parameters include parameters such as bold, space before paragraph (by pounds), row interval etc., the user can select at least one among them to make settings.

4) Take adjusting the picture size as an example, as shown in FIG. 3(e), the second parameters are the ratios of size of the original picture, the user can select any size ratio between 20% to 200% (including endpoints) to make settings.

5) Take adjusting the picture location as an example, as shown in FIG. 3(f), the second parameters are the two-dimensional plane coordinates (0, 0) to (X, Y), where X is a maximum value of width edge of the screen display area, Y is a maximum value of length edge of the screen display area, the user can select an arbitrary coordinate point between (0, 0) and (X, Y) (including endpoints) to make settings.

203. The electronic device receives a setting instruction, which carries a first parameter selected from second parameters.

The first parameter is a parameter selected by the user from the second parameters and used for adjusting the display content, that is, the first parameter acquired by the electronic device in step 101 in FIG. 1. As will be appreciated that, the first parameter and the second parameters are named differently only to differentiate a set of alternative parameters and the selected parameter, that is, the first parameter is a certain particular parameter selected by the user from the second parameters, actually, parameter attributes of both the first parameter and the second parameters are the same, the first parameter is a certain one among the second parameters.

Take font size as an example, the second parameters consist of twenty-three font sizes from font 8 to font 30, while the first parameter is one font size selected by the user from among the twenty-three font sizes, for example, font 20 in FIG. 3(b).

Preferably, when the second parameter is font size, an upper limit value of optional font sizes provided by the electronic device to the user is font 36, and a lower limit value of optional font sizes provided by the electronic device to the user is font 8. Upon a vast amount of experimental researches, it can be concluded that, based on the screen sizes of mainstream electronic devices in the current market, when the font size of the text displayed is less than font 8, the user will not be able to distinguish the text, and when the font size of the text displayed is more than font 36, the font size is too large and affects the user's viewing. Accordingly, this embodiment can provide a font size range with the broadest scope for the user to select on the basis of ensuring the user's viewing experience.

204. The electronic device looks up a display effect corresponding to the first parameter.

After the user selects the first parameter from the second parameters, the electronic device will looks up a display effect corresponding to the first parameter according to the first parameter and a preset mapping correspondence table. Take FIG. 3(b) as an example, when opening the setting dialog box, a default font size in the electronic device is font 16, the user selects font 20 by means of a physical navigation key or a touch-sensed screen, the electronic device looks up the display effect corresponding to font 20 in the mapping correspondence table as shown in step 102 in FIG. 1, so as to facilitate the displaying in the preview interface subsequently.

205. The electronic device displays the display effect in a preview interface.

When adjusting the text size, the electronic device displays the word “ [symbol] ” in font 20 in the preview interface as shown in FIG. 3(b), in order to facilitate the user viewing.

When adjusting the text style, usually the display effect of parameters such as row interval, space before paragraph (by pounds), or the like cannot be reflected through only one row, the electronic device can display at least two rows of text in the preview interface, in order to reflect the display effect.

It should be noted that, if the display content to be adjusted is characters (such as texts, symbols, letters, numbers, etc.), the preview interface can display only the characters which are taken as the adjustment object, but if the display content to be adjusted is an picture or an icon, the user cannot view a relative change (size or location) of the picture (icon) when the preview interface displays only the adjusted picture (icon), therefore, when adjusting the picture (icon), the electronic device needs to display a thumbnail containing the entire display area of the picture (icon) in the preview interface as shown in FIG. 3(e) or FIG. 3(f), so that the user takes the entire display area as a reference, and thereby adjusts the size or location of the picture (icon).

Alternatively, when the display content to be adjusted is characters, the electronic device may also display the display effect in the preview interface where there are reference lines as background lines, wherein the reference lines include at least one of the following: swastika grid, four-line grid, or staves. When adjusting the size of characters, the electronic device adds background lines in the preview area so as to provide reference for the characters whose font size has been changed, in order to facilitate the user comparing the different display effects, for example, the difference between the font size in FIG. 4(a) and FIG. 4(b) can be compared and seen by the swastika grid with an unchanged size; also, the difference between the font size in FIG. 4(c) and FIG. 4(d), can be compared and seen by the four-line grid with an unchanged size.

In this embodiment, the location of the preview interface may be set in the setting dialog box, for example, any one of FIG. 3(b) to FIG. 3(f); the preview interface may be also displayed translucently in the areas other than the setting dialog box in the entire display area. Preferably, as shown in FIG. 5, the preview interface may be translucently overlapped on the display content, and its size is the same as that of the display content. As for the case of moving the location of an picture (icon), such pre-displaying manner may have the actual display content as a movement range, so that the user can accurately oversee the movement to the picture (icon).

Further alternatively, when the electronic device pre-displays the display effect, it may also pop-up a prompt box prompting the user that the adjusted display content will mismatch a page layout, which impacts the viewing. For example, when adjusting the text size, the user is prompted that content on an individual page will be more than or less than the screen display area. Since different electronic devices have different models, page layout differences may exist among different electronic devices. As for the scenario where the browser accesses a web page, some text or picture will exceed the page dimensions, or be smaller than the page dimensions (space is left around the page) in rare cases where the electronic device rearranges the layout of the text data and image data acquired based on URL according to the adjusted first parameter. With respect to this case, the electronic device can preventively prompt the user, but no compulsive restriction is made to the adjustment behavior of the user.

206. If receiving a confirmation instruction, then the electronic device adjusts the display content according to the first parameter.

The electronic device adjusts the display content according to the first parameter acquired in step 203, and closes the setting dialog box, thus completing the display adjustment. If no confirmation instruction is received, then the electronic device re-executes steps 203 to 205 in sequence. If receiving a cancel instruction, then the electronic device closes the setting dialog box and makes no adjustment to the display content.

Alternatively, after completing the adjustment to the display content, the electronic device may also save the first parameter acquired in step 203, and sets the first parameter as a default adjustment parameter. When the user opens another page, the electronic device automatically adjusts the display content on the other page according to the default adjustment parameter; or, when displaying a page next time, the electronic device adjusts the display content on the page according to the default adjustment parameter. Thereby a learning process to usage habits of the user is achieved, and a more humanization adjustment manner is provided to the user.

In this embodiment, the method as shown in FIGS. 1 and 2 may be used to applications of a browser, and can make display adjustment to a page requested by the browser. In particular, take adjusting the text size as an example, the main flows that the electronic device adjusts the display content are shown in FIG. 6:

601. Receiving an adjusting instruction for adjusting the text size.

602. Popping up a font size setting dialog box.

603. Determining whether the user triggers a left navigation key.

604. If the determination result is Yes, then displaying the display effect of decreasing the font size and executing step 607.

605. If the determination result is No, then determining whether the user triggers a right navigation key.

606. If the determination result is Yes, then displaying the display effect of increasing the font size and executing step 607; if the determination result is No, then executing step 607.

607. Determining whether the user triggers the OK button or the cancel button.

608. If the determination result is that the user triggers the OK button, then saving the current font size and closing the font size setting dialog box, and thereafter performing step 610.

609. If the determination result is that user triggers the cancel button, then closing the font size setting dialog box, thus completing the font size setting.

610. Rearranging the layout of the text displayed on the page, thus completing the font size setting.

In this embodiment, the user can select the font size of text by means of a physical button (such as a navigation button), and can also select the font size of text by means of the touch-sensed display screen. As for adjusting the size or location of the picture (icon), the user can zoom in/out or make a location movement via a preset physical button, and can also use the fingers to directly execute a drag or stretch operation on the picture (icon) on the touch-sensed display screen, this embodiment makes no restriction to the manner by which the electronic device acquires the first parameter.

In this embodiment, the method as shown in FIGS. 1 and 2 may be also applied to, but not limited to, scenarios such as text editing, image editing, desktop management etc., in addition to the scenario of adjusting a browser page as shown in FIG. 6. Actually, applications/scenarios that relate to a display process are all applicable to the method provided in this embodiment.

The method for display adjustment provided in this embodiment is mainly applied to electronic devices such as mobile phones, computers, etc., it can acquire the first parameter used for adjusting the display content in the setting dialog box, look up the display effect corresponding to first parameter and display the display effect in the preview interface, when receiving the confirmation instruction, adjust the display content according to the first parameter and close the setting dialog box. As compared with that the mobile phone can display the adjusted display content only after the user sets an adjustment parameter and confirms an exit from the setting dialog box in the prior art, the present invention can pre-display an display effect corresponding to the parameter selected by the user during the process of setting the adjustment parameter, with respect to the case where the setting dialog box is a modal dialog box, the display effect can be provided to the user without closing the setting dialog box, therefore, the times of opening and closing the setting dialog box are reduced, and the user's operation steps are simplified.

In addition, the method for display adjustment provided in this embodiment can also save the first parameter set by the user as a default adjustment parameter, and automatically adjust the subsequent display content according to the default adjustment parameter. As for the scenario where user browses a plurality of pages via browser, the method can perform display adjustment to all the pages via a one-time setting, which further reduces the steps of user setting and simplifies the user's operation process.

With reference to the implementation of the foregoing method, this embodiment also provides an apparatus for display adjustment, the apparatus being applied in electronic devices. As shown in FIG. 7, the apparatus 71 includes: an acquiring unit 711, a looking-up unit 712, a displaying unit 713, a receiving unit 714, an adjusting unit 715, and a saving unit 716, wherein:
the acquiring unit 711 is for acquiring a first parameter in a setting dialog box, the first parameter being used for adjusting the display content;
the looking-up unit 712 is for looking up a display effect corresponding to the first parameter acquired by the acquiring unit 711;
the display unit 713 is for displaying the display effect looked up by the looking-up unit 712 in a preview interface;
the receiving unit 714 is for receiving a confirmation instruction; and
the adjusting unit 715 is for, when the receiving unit 714 receives the confirmation instruction, adjusting the display content according to the first parameter acquired by the acquiring unit 711 and closing the setting dialog box.

Furthermore, the acquiring unit 711 is further for receiving an adjusting instruction, the adjusting instruction being used to instruct to make an adjustment to the display content;
the display unit 713 is further for displaying the setting dialog box according to the adjusting instruction received by the acquiring unit 711, the setting dialog box displaying second parameters used for adjusting the display content; and
the acquiring unit 711 is further for receiving a setting instruction, the setting instruction carrying the first parameter selected from the second parameters.

Furthermore, the display unit 713 is further for, when the display content is characters, displaying the display effect looked up by the looking-up unit 712 in a preview interface having reference lines as background lines, wherein the reference lines include at least one of the following: swastika grid, four-line grid, or staves.

Furthermore, the saving unit 716 is further for, after the adjusting unit 715 adjusts the display content according to the first parameter acquired by the acquiring unit 711, saving the first parameter acquired by the acquiring unit 711; and
the adjusting unit 715 is further for adjusting the display content on another page according to the first parameter saved by the saving unit 716, or when displaying a page next time, adjusting the display content on the page according to the first parameter saved by the saving unit 716.

The apparatus 71 for display adjustment provided in this embodiment can be located in electronic devices such as mobile phones, PDA, computers etc., it can acquire the first parameter used for adjusting the display content in the setting dialog box, look up the display effect corresponding to first parameter and display the display effect in the preview interface, when receiving the confirmation instruction, adjust the display content according to the first parameter and close the setting dialog box. As compared with that the mobile phone can display the adjusted display content only after the user sets an adjustment parameter and confirms an exit from the setting dialog box in the prior art, the present invention can pre-display an display effect corresponding to the parameter selected by the user during the process of setting the adjustment parameter, with respect to the case where the setting dialog box is a modal dialog box, the display effect can be provided to the user without closing the setting dialog box, therefore, the times of opening and closing the setting dialog box are reduced, and the user's operation procedures are simplified.

In addition, the apparatus 71 for display adjustment provided in this embodiment can save the first parameter set by the user as a default adjustment parameter, and automatically adjust the subsequent display content according to the default adjustment parameter. As for the scenario where the user browses a plurality of pages via browser, the method can perform display adjustment on all the pages via a one-time setting, which further reduces the steps of user setting and simplifies the user's operation process.

Through the above description of the implementing modes, a person of skill in the art can clearly understand that the present invention can be implemented by means of software plus necessary universal hardware, and certainly it can be also implemented by means of hardware, but the former is a better embodiment in many cases. Based on such understanding, the essence of the technical solutions of the present invention or the part that contributes to the prior art may be embodied in form of a computer software product, the computer software product being stored in a readable storage medium such as a floppy disk, a hard disk, or an optical disk of computers, including several instructions for enabling a computer device (which may be a personal computer, a server, or network equipment etc.) to execute the methods in the respective embodiments of the present invention.

The above described are only specific implementing modes of the present invention, but the protection scope of the present invention is not limited thereto, and any variables or alternatives that are easily conceivable for a person of skill in the art within the technical disclosure of the present invention are intended to be within the protection scope of the present invention. Therefore, the protection scope of the present invention should be in accordance with the protection scope of the attached claims.

What is claimed is:

1. A method for display adjustment, including:
acquiring a first parameter, the first parameter being used for adjusting display content;
displaying a display effect corresponding to the first parameter in a preview interface; and
if receiving a confirmation instruction, then adjusting the display content according to the first parameter.

2. The method for display adjustment according to claim 1, wherein the step of acquiring a first parameter includes:
receiving an adjusting instruction, the adjusting instruction being used for instructing to make an adjustment to the display content;
displaying the setting dialog box according to the adjusting instruction, the setting dialog box displaying second parameters used for adjusting the display content; and
receiving a setting instruction, the setting instruction carrying the first parameter selected from the second parameters.

3. The method for display adjustment according to claim 1, wherein the step of displaying a display effect corresponding to the first parameter in a preview interface includes:
when the display content is characters, displaying the display effect in a preview interface having reference lines as background lines, the reference lines including at least one of: swastika grid, four-line grid, or staves.

4. The method for display adjustment according to claim 3, wherein when the second parameter is font size, an upper limit value of font size is font 36, and a lower limit value of font size is font 8.

5. The method for display adjustment according to claim 4, wherein after adjusting the display content according to the first parameter, the method further includes:
saving the first parameter; and
adjusting the display content on another page according to the first parameter, or when displaying a page next time, adjusting the display content on the page according to the first parameter.

6. The method for display adjustment according to claim 1, wherein when the display content is characters, the second parameters are at least one of: font size, font, or style; and
when the display content is an picture or an icon, the second parameters are: size or location.

7. The method for display adjustment according to claim 1, wherein prior to the step of displaying a display effect corresponding to the first parameter in a preview interface, the method further includes:
looking up the technical effect corresponding to the first parameter.

8. An apparatus for display adjustment, including:
an acquiring unit for acquiring a first parameter, the first parameter being used for adjusting the display content;
a display unit for displaying a display effect corresponding to the first parameter in a preview interface;
a receiving unit for receiving a confirmation instruction; and
an adjusting unit for, when the receiving unit receives the confirmation instruction, adjusting the display content according to the first parameter acquired by the acquiring unit.

9. The apparatus for display adjustment according to claim 8, wherein the acquiring unit is further for receiving an adjusting instruction, the adjusting instruction being used for instructing to make an adjustment to the display content;
the display unit is further for displaying the setting dialog box according to the adjusting instruction received by the acquiring unit, the setting dialog box displaying second parameters used for adjusting the display content; and
the acquiring unit is further for receiving a setting instruction, the setting instruction carrying the first parameter selected from the second parameters.

10. The apparatus for display adjustment according to claim 8, wherein the display unit is further for, when the display content is characters, displaying the display effect looked up by the looking-up unit in a preview interface having reference lines as background lines, the reference lines including at least one of: swastika grid, four-line grid, or staves.

11. The apparatus for display adjustment according to claim 10, wherein the apparatus further includes:
a saving unit for, after the adjusting unit adjusts the display content according to the first parameter acquired by the acquiring unit, saving the first parameter acquired by the acquiring unit; and
the adjusting unit is further for adjusting the display content on another page according to the first parameter saved by the saving unit, or when displaying a page next time, adjusting the display content on the page according to the first parameter saved by the saving unit.

12. The apparatus for display adjustment according to claim 10, wherein the apparatus further includes:
a looking-up unit for looking up the display effect corresponding to the first parameter acquired by the acquiring unit.

13. A mobile terminal, comprising an apparatus for display adjustment, the apparatus for display adjustment including:
an acquiring unit for acquiring a first parameter, the first parameter being used for adjusting the display content;
a display unit for displaying a display effect corresponding to the first parameter in a preview interface;
a receiving unit for receiving a confirmation instruction; and
an adjusting unit for, when the receiving unit receives the confirmation instruction, adjusting the display content according to the first parameter acquired by the acquiring unit.

14. The mobile terminal according to claim 13, wherein the acquiring unit is further for receiving an adjusting instruction, the adjusting instruction being used for instructing to make an adjustment to the display content;
the display unit is further for displaying the setting dialog box according to the adjusting instruction received by the acquiring unit, the setting dialog box displaying second parameters used for adjusting the display content; and
the acquiring unit is further for receiving a setting instruction, the setting instruction carrying the first parameter selected from the second parameters.

15. The mobile terminal according to claim 13, wherein the display unit is further for, when the display content is characters, displaying the display effect looked up by the looking-up unit in a preview interface having reference lines as background lines, the reference lines including at least one of: swastika grid, four-line grid, or staves.

16. The mobile terminal according to claim 15, wherein the apparatus for display adjustment further includes:
a saving unit for, after the adjusting unit adjusts the display content according to the first parameter acquired by the acquiring unit, saving the first parameter acquired by the acquiring unit; and
the adjusting unit is further for adjusting the display content on another page according to the first parameter saved by the saving unit, or when displaying a page next time, adjusting the display content on the page according to the first parameter saved by the saving unit.

17. The mobile terminal according to claim 15, wherein the apparatus for display adjustment further includes:
a looking-up unit for looking up the display effect corresponding to the first parameter acquired by the acquiring unit.
